(19) United States
(12) Patent Application Publication
(10) Pub. No.: US 2017/0015280 A1
(43) Pub. Date: Jan. 19, 2017

(54) WIPER BLADE ASSEMBLY

(71) Applicant: CAP CORPORATION, Sangju-si, Gyeongsangbuk-ro (KR)

(72) Inventors: SEUNG CHUL HYUN, Ansan-si (KR); Tae Hun KIM, Daegu (KR)

(73) Assignee: CAP CORPORATION, Sangju-si, Gyeongsangbuk-ro (KR)

(21) Appl. No.: 15/301,090

(22) PCT Filed: Mar. 31, 2015
(86) PCT No.: PCT/KR2015/003165

§ 371 Date: Sep. 30, 2016

(30) Foreign Application Priority Data
Apr. 2, 2014 (KR) 10-2014-0039379
Apr. 2, 2014 (KR) 10-2014-0039410

(51) Int. Cl. B60S 1/40; B60S 1/38

(52) U.S. Cl. CPC B60S 1/4006; B60S 1/3856

(57) ABSTRACT

The present invention relates to a wiper blade assembly comprising a hinge shaft coupled to a wiper arm, wherein the wiper arm is directly coupled to the hinge shaft. The present invention can provide a wiper blade assembly in which a beginner can also easily engage and disengage the wipe arm and the wiper blade assembly.

### TECHNICAL FIELD

The present inventive concept relates to a wiper blade assembly, and more particularly, to a wiper blade assembly to or from which a wiper arm can be easily coupled or decoupled.

### BACKGROUND ART

A wiper blade assembly is placed on the windshield of a vehicle to wipe rain or remove foreign matter in order to secure the driver's view. The wiper blade assembly is connected to and driven by a wiper arm which is connected to a drive shaft connected to a wiper driving motor of the vehicle.

Here, the wiper arm and the wiper blade assembly are coupled to each other by a wiper connector. Generally, a member called an adapter is provided in the wiper blade assembly. A connector member is coupled to the adapter, and the wiper arm is coupled to the connector member.

FIG. 1 is a perspective view of a wiper blade assembly having a general structure. FIG. 2 is a perspective view of a wiper arm having a general structure. FIG. 3 is a perspective view of a connector member coupled to the wiper arm having the general structure.

Referring to FIGS. 1, 2 and 3, a wiper blade assembly 10 having a general structure includes a rubber wiper strip (not illustrated) which contacts the windshield of a vehicle, a pair of spoilers 11, and an adapter 12 which is located in a specific area of the wiper blade assembly in a lengthwise direction of the wiper blade assembly.

In the drawings, the adapter is located in a central area of the wiper blade assembly in the lengthwise direction of the wiper blade assembly. However, the adapter can be placed in either the central area or a peripheral area as desired.

Referring continuously to FIGS. 1, 2 and 3, the adapter 12 of the wiper blade assembly 10 having the general structure includes a connector member 13 to which a wiper arm 15 is coupled and a connector housing part 14 in which the connector member 13 is housed.

Here, the wiper arm 15 may be connected to a drive shaft which is connected to a wiper driving motor of the vehicle, and the wiper blade assembly 10 may be driven by the driving of the wiper arm.

That is, a wiper blade assembly having a general structure such as the one described above includes a member called an adapter, and a connector member is coupled to a specific area, i.e., a connector housing part of the adapter. And the wiper arm is coupled to the connector member.

Generally, the connector housing part includes a hinge shaft (not illustrated) formed integrally with the connector housing part. Therefore, the connector member can be coupled to the hinge shaft.

In the wiper blade assembly having the general structure, however, the connector member is needed to couple the wiper arm to the adapter.

In addition, in this structure, it is not easy for a beginner to couple the wiper arm to the adapter because he or she does not know to which part of the wiper blade assembly the wiper arm should be coupled.

In this structure, it is also not easy for the beginner to decouple the wiper arm from the adapter. Ultimately, the beginner may have difficulty separating the wiper arm and the wipe blade assembly to replace the wiper blade assembly.

### DISCLOSURE

### Technical Problem

Aspects of the inventive concept provide a wider blade assembly to or from which a wiper arm can be easily coupled or decoupled.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

### Technical Solution

According to an aspect of the inventive concept, there is provided a wiper blade assembly including a hinge shaft coupled to a wiper arm, wherein the wiper arm is directly coupled to the hinge shaft.

In addition, the wiper arm includes a U-shaped hook, wherein the U-shaped hook includes an inner circumferential surface, and the hinge shaft includes an outer circumferential surface, wherein at least a portion of the inner circumferential surface of the hook contacts at least a portion of the outer circumferential surface of the hinge shaft.

According to another aspect of the inventive concept, there is provided a wiper blade assembly coupled to a wiper arm and including a hinge shaft, wherein the hinge shaft includes a first hinge shaft and a second hinge shaft separated from the first hinge shaft by a predetermined gap, wherein the predetermined gap is adjusted.

In addition, the wiper blade assembly includes: a coupling cover which covers a specific area of an elastic member and is coupled to the elastic member; an adapter which is attached to or detached from the coupling cover; and a hinge member which is located in a specific space inside the adapter, is coupled to the adapter, and provides the hinge shaft to the wiper arm.

In addition, the hinge member includes a first hinge shaft part and a second hinge shaft part which is separated from the first hinge shaft part by a predetermined gap, and the hinge shaft includes a first hinge shaft and a second hinge shaft, wherein the first hinge shaft part includes a first vertical body, a first horizontal body which extends from the first vertical body in a first direction and the first hinge shaft which provides toward the inside of the first horizontal body, and the second hinge shaft part includes a second vertical body, a second horizontal body which extends from the second vertical body in the first direction and the second hinge shaft which protrudes toward the inside of the second horizontal body.

In addition, the first hinge shaft part includes a first coupling part which is located in a bore of the first vertical body, and the second hinge shaft part includes a second coupling part which is located in a bore of the second vertical body.

In addition, the first hinge shaft part includes a first support part which extends from the first vertical body in the first direction and is separated from the first horizontal body, and the second hinge shaft part includes a second support part which extends from the second vertical body in the first direction and is separated from the second horizontal body.

In addition, the hinge member further includes a hinge shaft gap adjusting member, the hinge shaft gap adjusting member includes a base member which is located at an upper end of the hinge member and adjacent to the first hinge shaft part and the second hinge shaft part, a pressing member which extends from a first end of the base member, and a connecting member which extends from a second end of the base member.

In addition, an end of the connecting member is connected to the second end of the base member, and the other end of the connecting member is connected to the hinge shaft parts, and the connecting member includes a first connecting member which has an end connected to the second end of the base member and the other end connected to the first hinge shaft part and a second connecting member which is separated from the first connecting member by a predetermined gap and has an end connected to the second end of the base member and the other end connected to the second hinge shaft part.

In addition, the gap between the first hinge shaft and the second hinge shaft after the pressing member is pressed is greater than the gap between the first hinge shaft and the second hinge shaft before the pressing member is pressed.

In addition, the adapter includes: a body; a wiper arm housing part which is located in a specific area of the body; and an insertion protrusion part which is located in an area inside the body and adjacent to an end of the wiper arm housing part, wherein the insertion protrusion part includes a first insertion protrusion and a second insertion protrusion separated from the first insertion protrusion by a predetermined gap, wherein the first insertion protrusion is inserted into the first coupling part, and the second insertion protrusion is inserted into the second coupling part.

In addition, the adapter includes: a body; a wiper arm housing part which is located in a specific area of the body; and a blocking member which is located in an area inside the body and adjacent to an end of the wiper arm housing part, wherein the blocking member includes a first blocking member which blocks continuous insertion of the wiper arm inserted into the wiper arm housing part and a second blocking member which is inserted into a space between the first connecting member and the second connecting member of the hinge member.

In addition, the adapter includes: a body; a wiper arm housing part which is located in a specific area of the body; and a support groove which is located in an area inside the body and in an area of the wiper arm housing part, wherein the support groove includes a first support groove and a second support groove separated from the first support groove by a predetermined gap, wherein the first support part is inserted into the first support groove, and the second support part is inserted into the second support groove.

### Advantageous Effects

According to the inventive concept, a wiper blade assembly to or from which a wiper arm can be easily coupled or decoupled even by a beginner can be provided.

### DESCRIPTION OF DRAWINGS

FIG. 1 is a perspective view of a wiper blade assembly having a general structure;

FIG. 2 is a perspective view of a wiper arm having a general structure, and

FIG. 3 is a perspective view of a connector member coupled to the wiper arm having the general structure;

FIG. 4 is a coupled perspective view of a wiper blade assembly according to the inventive concept, and FIG. 5 is an exploded perspective view of the wiper blade assembly according to the inventive concept;

FIGS. 6 through 9 are perspective views illustrating the coupling structure between a coupling cover and an adapter of the wiper blade assembly according to the inventive concept;

FIG. 10 is a perspective view of a wiper arm of the wiper blade assembly according to the inventive concept;

FIGS. 11 through 13 are perspective views of a hinge member of the wiper blade assembly according to the inventive concept;

FIGS. 14 through 18 are schematic views illustrating a process of coupling the wiper arm directly to the hinge member according to the inventive concept; and

FIGS. 19 and 20 illustrate a process of coupling the adapter and the hinge member to each other according to the inventive concept.

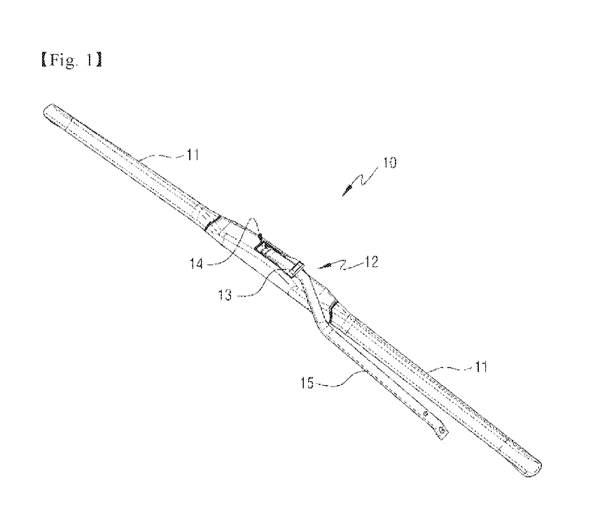

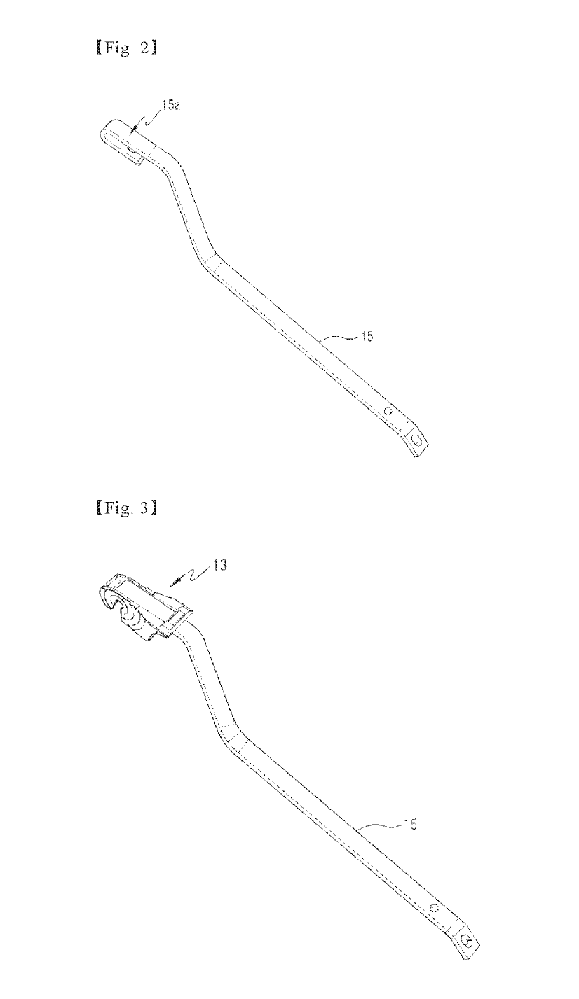

### BEST MODE

Advantages and features of the inventive concept and methods of accomplishing the same may be understood more readily by reference to the following detailed description of exemplary embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the invention to those skilled in the art, and the inventive concept will only be defined by the appended claims.

Specific embodiments of the inventive concept will be described in detail with reference to the accompanying drawings. Like reference numerals refer to like components regardless of the drawings. As used herein, the term “and/or” includes any and all combinations of one or more of the associated listed items.

It will be understood that, although the terms first, second, third, etc., may be used herein to describe various components, these components should not be limited by these terms. These terms are only used to distinguish one component from another component. Thus, a first component discussed below could be termed a second component without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, but do not preclude the presence or addition of one or more other components.

Unless otherwise defined, all terms (including technical and scientific terms) used herein have the same meaning as commonly understood by one of ordinary skill in the art to which this inventive concept belongs. It will he further understood that terms, such as those defined in commonly used dictionaries, should be interpreted as having a meaning that is consistent with their meaning in the context of the relevant art and will not be interpreted in an idealized or overly formal sense unless expressly so defined herein.

Spatially relative terms, such as “below,” “beneath,” “lower,” “above,” “upper” and the like, may be used herein for ease of description to describe the relationship of one component or feature to another component(s) or feature(s) as illustrated in the figures. It will be understood that the spatially relative terms are intended to encompass different orientations of the device in use or operation, in addition to the orientation depicted in the figures. For example, if the device in the figures is turned over, components described as “below” or “beneath” other components or features would then be oriented “above” the other components or features. Thus, the exemplary term “below” or “beneath” can encompass both an orientation of above and below or beneath. The component may be otherwise oriented and the spatially relative descriptors used herein interpreted accordingly.

Hereinafter, exemplary embodiments of the inventive concept will be described in detail with reference to the accompanying drawings.

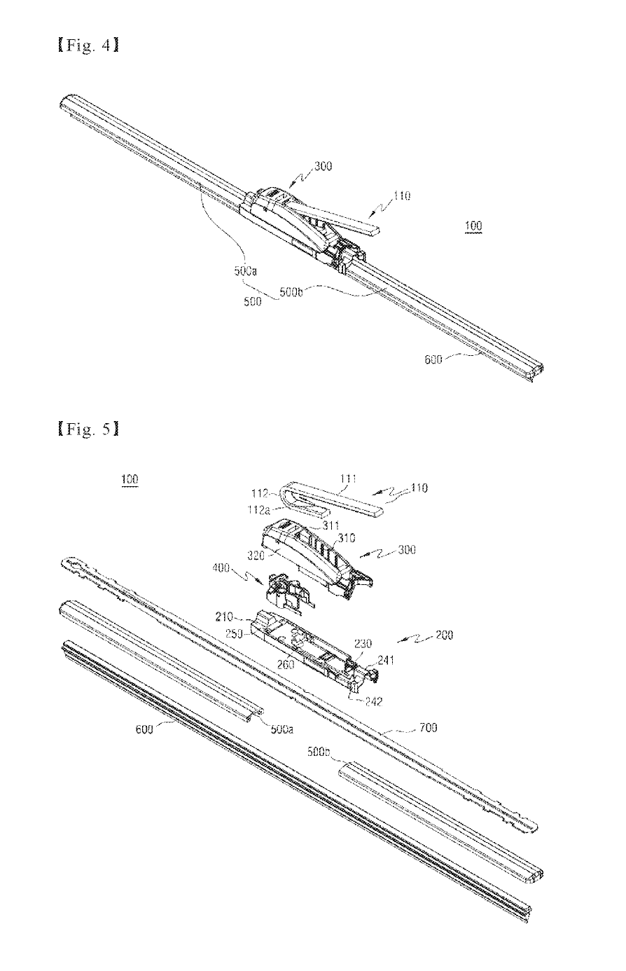

FIG. 4 is a coupled perspective view of a wiper blade assembly according to the inventive concept. FIG. 5 is an exploded perspective view of the wiper blade assembly according to the inventive concept.

FIGS. 4 and 5, a flat-type wiper blade assembly is illustrated. However, the inventive concept is not limited by the type of a wiper blade assembly.

That is, the type of a wiper blade assembly may be broadly divided into a conventional type and a flat type according to the structure of a blade. In the conventional type, a plurality of yokes curved in the shape of bows are vertically coupled to each other to apply an elastic force to a rubber strip which contacts the windshield of a vehicle so as to press the rubber strip against the vehicle windshield. In the flat type, the above yokes are not provided. Instead, a single elastic support member is provided. The inventive concept is applicable regardless of the type of a wiper blade assembly.

Referring to FIGS. 4 and 5, a wiper blade assembly 100 according to the inventive concept includes a rubber contact member 600 which contacts the windshield of a vehicle, an elastic member 700 which supports the contact member, and a pair of cover members 500a and 500b which cover the elastic member. In addition, the wiper blade assembly 100 includes a coupling cover 200 which is located in a specific area of the wiper blade assembly in a lengthwise direction of the wiper blade assembly and includes a housing part.

The coupling cover 200 may cover a specific area of the elastic member and may be coupled to the elastic member 700.

Referring continuously to FIGS. 4 and 5, the wiper blade assembly 100 according to the inventive concept includes an adapter 300 which is attached to or detached from the housing part of the coupling cover 200.

In the drawings, the coupling cover is located in a central area of the wiper blade assembly in the lengthwise direction of the wiper blade assembly. However, the coupling cover can also be placed in either the central area or a peripheral area as desired. Therefore, the position of the coupling cover is not limited to a particular position in the inventive concept.

Although not illustrated in the drawings, a wiper arm may be coupled to a specific area of the wiper blade assembly, that is, to a hinge member 400 which will be described later. Therefore, the wiper blade assembly may be wiped by the power transmitted from the wiper arm.

Referring continuously to FIGS. 4 and 5, the wiper blade assembly 100 may include the hinge member 400 which is located in a specific space inside the adapter 300 to be coupled to the adapter 300 and provides a hinge shaft to the wiper arm.

That is, in the inventive concept, the hinge shaft is provided through the hinge member 400 which is located in the specific space inside the adapter 300 to be coupled to the adapter 300. Here, in the inventive concept, the wiper arm is directly coupled to the hinge shaft of the hinge member 400. This will be described later.

The wiper blade assembly according to the inventive concept will be described below.

FIGS. 6 through 9 are perspective views illustrating the coupling structure between the coupling cover and the adapter of the wiper blade assembly according to the inventive concept. In FIGS. 6 through 9, the coupling structure only between the coupling cover and the adapter of the wiper blade assembly will be described for ease of description, and the hinge member according to the inventive concept will be described later.

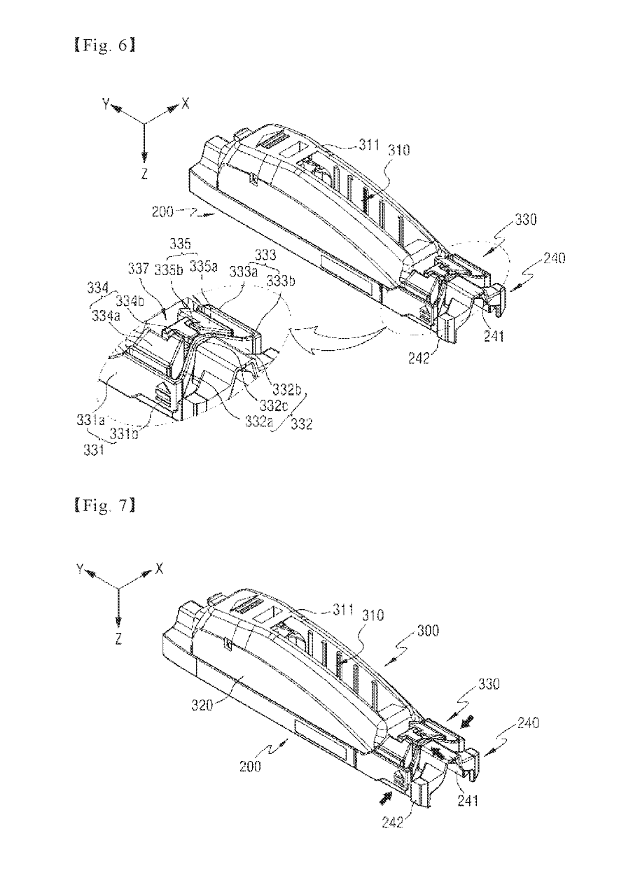

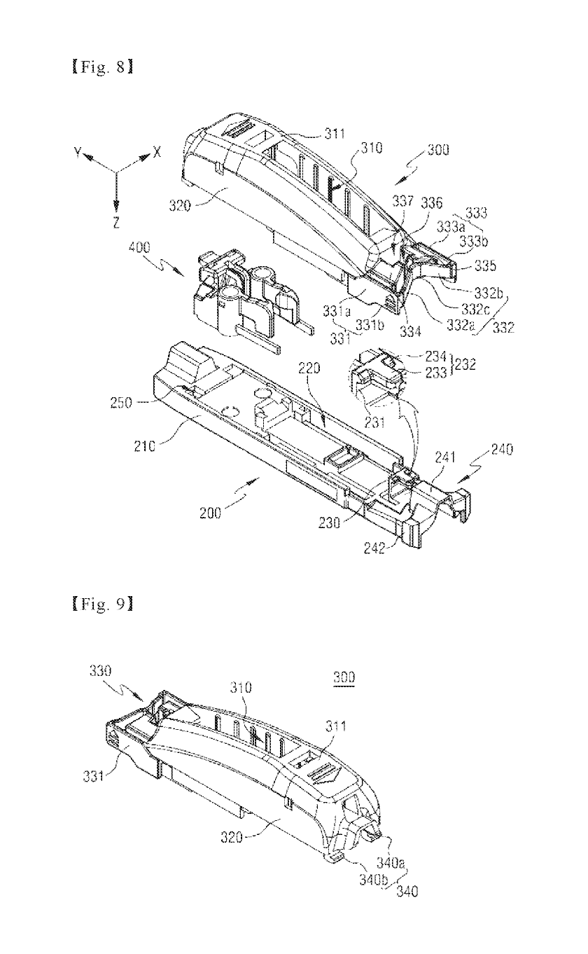

Here, FIG. 6 is a perspective view of the coupling cover and the adapter coupled to each other. FIG. 7 is a perspective view illustrating a process of separating the adapter from the coupling cover. FIG. 8 is a perspective view of the coupling cover and the adapter separated from each other. FIG. 9 is a perspective view of the adapter viewed from a different direction.

Referring to FIGS. 6 through 9, the coupling cover 200 of the wiper blade assembly according to the inventive concept includes a body 210 and a housing part 220 located in a specific area of the body 210. That is, the adapter may be housed in the housing part 220 and thus coupled to the housing part 220.

The housing part 220 includes a first coupling part 230 at a side and a second coupling part 250 at the other side.

The first coupling part 230 includes a first protrusion 231 which extends in a heightwise direction Z of the coupling cover and a second protrusion 232 which extends in a lengthwise direction Y of the coupling cover.

Here, an end of the first protrusion 231 extends from a specific area of the housing part 220, and the other end of the first protrusion 231 extends to the second protrusion 232.

In addition, the second protrusion 232 includes a catching part 234 which extends to a predetermined length and a protruding part 233 which extends in the same direction as the catching part 234 to a length greater than the predetermined length of the catching part 234.

In addition, the second coupling part 250 may be formed in the shape of a coupling groove or a coupling hole. Therefore, in the inventive concept, the adapter may be coupled to the coupling cover 200 by the first coupling part 230 and the second coupling part 250 of the housing part 220. This will be described later.

Referring continuously to FIGS. 6 through 9, the coupling cover 200 of the wiper blade assembly according to the inventive concept includes an auxiliary body 240 which is located in a specific direction of the body, specifically, in a direction in which the protruding part 233 extends. The auxiliary body 240 includes a horizontal auxiliary body 241 and a vertical auxiliary body 242. The vertical auxiliary body 242 protrudes in a widthwise direction X of the auxiliary body 240. This will be described later.

The adapter 300 of the wiper blade assembly according to the inventive concept includes a body 320 and a wiper arm housing part 310 located in a specific area of the body 320. That is, the wiper arm is inserted into the wiper arm housing part 310 to be located in the specific space inside the adapter 300 as described above. Therefore, the wiper arm may be directly coupled to the hinge shaft of the hinge member 400 which is coupled to the adapter 300.

The adapter 300 further includes a third coupling part 330 which is located at a side of the body 320 and a fourth coupling part 340 (see FIG. 9) which is located at the other side of the body 320.

The third coupling part 330 includes a pressing structure, and the pressing structure includes a first pressing part 331, a connecting part 332, and a second pressing part 333.

More specifically, the pressing structure includes the first pressing part 331 and the second pressing part 333 which extend from a side of the body 320 and the connecting part 332 which connects the first pressing part 331 and the second pressing part 333.

Here, the connecting part 332 includes a first connecting part 332a which is connected to the first pressing part 331, a second connecting part 332b which is connected to the second pressing part 333, and a pressing point 332c which is located in an area in which the first connecting part 332a and the second connecting part 332b contact each other.

In addition, a side of the first pressing part 331 includes a first connecting point 331a which is connected to a side of the body 320 and a second connecting point 331b which is connected to the first connecting part 332a. A side of the second pressing part 333 includes a third connecting point 333a which is connected to the side of the body 320 and a fourth connecting point 333b which is connected to the second connecting part 332b.

That is, as illustrated in the drawings, the first pressing part 331, the connecting part 332 and the second pressing part 333 of the pressing structure are connected to each other to form an “M” shape. In addition, a side of the first pressing part and a side of the second pressing part are connected to the body.

Referring continuously to FIGS. 6 through 9, the third coupling part 330 of the adapter 300 of the wiper blade assembly according to the inventive concept includes a coupling structure which is located inside the pressing structure and separated from the pressing structure by a predetermined gap.

The coupling structure includes a first support 334 and a second support 335 separated from the first support 334 by a predetermined gap.

In addition, the coupling structure includes a first coupling groove 337 which is formed by the predetermined gap between the first support 334 and the second support 335 and a second coupling groove 336 which extends from the first coupling groove 337.

More specifically, the first support 334 includes a first lengthwise support 334a which extends in the lengthwise direction Y of the adapter 300 and a first widthwise support 334b which extends in the widthwise direction X of the adapter 300. The second support 335 includes a second lengthwise support 335a which extends in the lengthwise direction Y of the adapter 300 and a second widthwise support 335b which extends in the widthwise direction X of the adapter 300.

In addition, the first coupling groove 337 may be formed by a gap between the first lengthwise support 334a and the second lengthwise support 335a, and the second coupling groove 336 may be formed by a gap between the first widthwise support 334b and the second widthwise support 335b.

### Mode for Invention

The coupling and decoupling of the coupling cover 200 to and from the adapter 300 will now be described.

First, FIG. 6 illustrates the coupling cover and the adapter coupled to each other. Referring to reference characters of FIGS. 6 through 8, the fourth coupling part 340 (see FIG. 9) of the adapter 300 is coupled to the second coupling part 250 of the coupling cover of FIG. 8. Then, the third coupling part 330 of the adapter 300 and the first coupling part 230 of the coupling cover 200 are coupled to each other.

Here, when the third coupling part 330 of the adapter 300 is coupled to the first coupling part 230 of the coupling cover 200, the second protrusion 232 extending in the lengthwise direction Y of the coupling cover is located in the first coupling groove 337 formed by the predetermined gap between the first support 334 and the second support 335 and in the second coupling groove 336 extending from the first coupling groove 337.

Specifically, the second protrusion 232 includes the catching part 234 which extends to a predetermined length and the protruding part 233 which extends in the same direction as the catching part 234 to a length greater than the predetermined length of the catching part 234.

In addition, the first support 334 includes the first lengthwise support 334a which extends in the lengthwise direction Y of the adapter 300 and the first widthwise support 334b which extends in the widthwise direction X of the adapter 300, and the second support 335 includes the second lengthwise support 335a which extends in the lengthwise direction Y of the adapter 300 and the second widthwise support 335b which extends in the widthwise direction X of the adapter 300.

The first coupling groove 337 may be formed by the gap between the first lengthwise support 334a and the second lengthwise support 335a, and the second coupling groove 336 may be formed by the gap between the first widthwise support 334b and the second widthwise support 335b.

In this case, the catching part 234 may be located in the first coupling groove 337, and the protruding part 233 may be located in the second coupling groove 336.

The catching part 234 may be caught on the first widthwise support 334b and the second widthwise support 335b, thereby preventing the third coupling part 330 of the adapter 300 from being detached from the first coupling part 230 of the coupling cover 200.

Next, FIG. 7 illustrates the process of separating the adapter from the coupling cover. The adapter may be separated from the coupling cover by the pressing structure of the third coupling part 330 of the adapter 300.

More specifically, the pressing structure includes the first pressing part 331 and the second pressing part 333 which extend from a side of the body 320 and the connecting part 332 which connects the first pressing part 331 and the second pressing part 333.

In addition, a side of the first pressing part 331 includes the first connecting point 331a which is connected to a side of the body 320 and the second connecting point 331b which is connected to the first connecting part 332a, and a side of the second pressing part 333 includes the third connecting point 333a which is connected to the side of the body 320 and the fourth connecting point 333b which is connected to the second connecting part 332b.

Here, since the first connecting point 331a and the third connecting point 333a are connected and fixed to the body, they provide a base point. When a user presses the second connecting point 331b and the fourth connecting point 333b in the widthwise direction, the pressing point 332c located in the area in which the first connecting part 332a and the second connecting part 332b contact each other is moved in the lengthwise direction Y (see FIG. 3) by the pressing force.

The pressing point 332c presses the protruding part 233 of the adapter 300 in the lengthwise direction Y (see FIG. 3), thereby causing the catching part 234 to be pressed in the lengthwise direction Y (see FIG. 3). Accordingly, the catching part 234 caught on the first widthwise support 334b and the second widthwise support 335b is disengaged from the first widthwise support 334b and the second widthwise support 335b. Therefore, the third coupling part 330 of the adapter 300 and the first coupling part 230 of the coupling cover 200 are separated from each other.

Then, if the fourth coupling part 340 (see FIG. 9) of the adapter 300 is separated from the second coupling part 250 of the coupling cover, the coupling cover and the adapter are finally separated from each other as illustrated in FIG. 8.

In the above method of coupling the coupling cover and the adapter, components for coupling the coupling cover and the adapter to each other and components for decoupling the coupling cover and the adapter from each other are provided separately. Therefore, the adapter can be easily separated from the coupling cover.

In addition, in the inventive concept, detachable components located on a side surface of the adapter can be pressed not at an upper surface of the coupling cover but at a side surface of the coupling cover without being interfered by other parts. Therefore, the adapter can be easily separated from the coupling cover.

As described above, the coupling cover 200 of the wiper blade assembly according to the inventive concept includes the auxiliary body 240 located in a specific direction of the body, specifically, in the direction in which the protruding part 233 extends. The auxiliary body 240 includes the horizontal auxiliary body 241 and the vertical auxiliary body 242, and the vertical auxiliary body 242 protrudes in the widthwise direction X of the auxiliary body 240.

As described above, in the inventive concept, detachable components located on a side surface of the adapter can be pressed not at the upper surface of the coupling cover but at a side surface of the coupling cover without being interfered by other parts. Therefore, the adapter can be easily separated from the coupling cover.

For this reason, however, the detachable components located on the side surface of the adapter can be pressed without the intention of a user, thus causing the adapter and the coupling cover to be separated from each other.

Therefore, in the inventive concept, a height of the vertical auxiliary body 242 which protrudes in the widthwise direction X of the auxiliary body 240 may be equal to or greater than that of a surface of each of the first pressing part 331 and the second pressing part 333. This can prevent the first pressing part and the second pressing part from being pressed without intention.

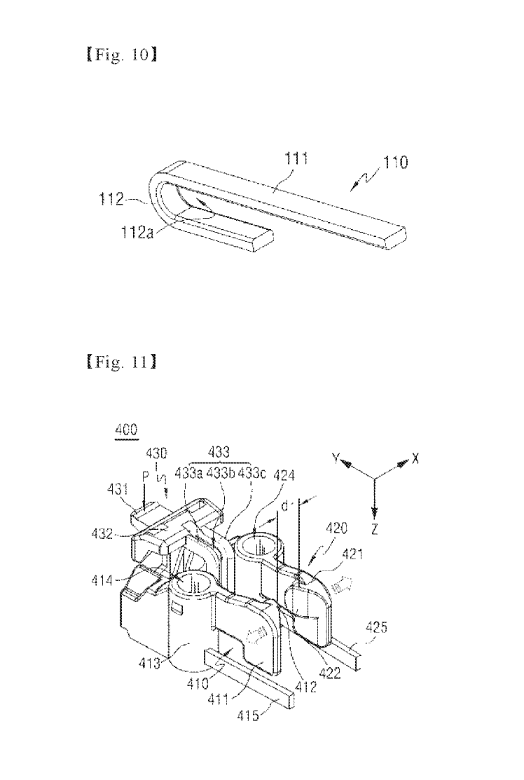

FIG. 10 is a perspective view of a wiper arm of the wiper blade assembly according to the inventive concept. Here, the wiper arm may be included in the wiper blade assembly. However, since the wiper arm is a part connected to a drive shaft which is connected to a wiper driving motor of a vehicle, it may actually not be included in the viper blade assembly. For ease of description, however, the wiper arm may be included in the wiper blade assembly in the inventive concept.

Referring to FIG. 10, a wiper arm 110 of the wiper blade assembly according to the inventive concept may generally include a lengthwise support 111 and a U-shaped hook 112 located at a front end of the lengthwise support 111.

Here, an inner circumferential surface 112a may be provided on the inside of the hook 112. In the inventive concept, the inner circumferential surface 112a of the hook 112 may contact an outer circumferential surface of a hinge shaft of the hinge member 400 as will be described later. Accordingly, the wiper arm may be directly coupled to the hinge shaft.

That is, a U-shaped part located at a front end of the wiper arm may be interlocked and thus fixed to the hinge shaft of the hinge member 400. Therefore, in the inventive concept, the wiper arm 110 may be coupled to the hinge shaft of the hinge member 400 as the inner circumferential surface 112a of the hook 112 contacts the outer circumferential surface of the hinge shaft of the hinge member 400.

Since the structure of the wiper arm is obvious to those of ordinary skill in the art, a detailed description of the structure will be omitted.

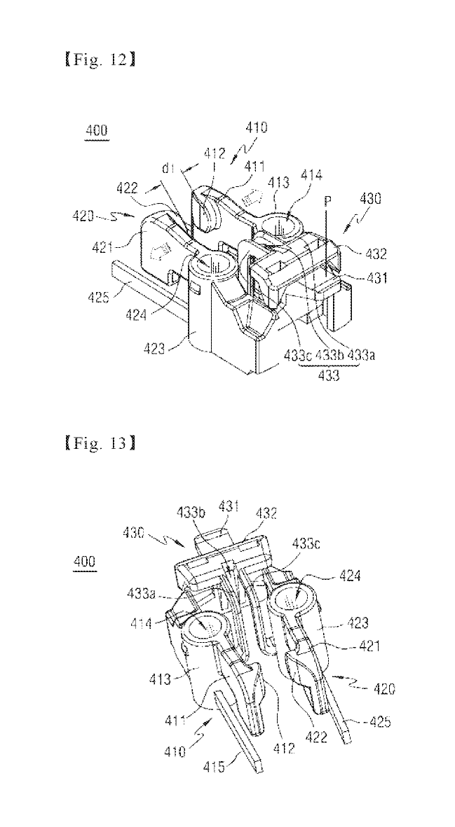

FIGS. 11 through 13 are perspective views of the hinge member of the wiper blade assembly according to the inventive concept. In FIGS. 11 through 13, the hinge member viewed from various directions is illustrated for ease description of the structure of the hinge member.

Referring to FIGS. 11 through 13, the hinge member 400 of the wiper blade assembly according to the inventive concept includes a first hinge shaft part 410 and a second hinge shaft part 420 separated from the first hinge shaft 410 by a predetermined gap.

More specifically, the first hinge shaft part 410 includes a first vertical body 413 and a first horizontal body 411 which extends in a first direction (an opposite direction to Y) from the first vertical body 413. The second hinge shaft part 420 includes a second vertical body 423 and a second horizontal body 421 which extends in the first direction (the opposite direction to Y) from the second vertical body 423.

In addition, a first hinge shaft 412 which protrudes toward the inside of the first horizontal body 411 and a second hinge shaft 422 which protrudes toward the inside of the second horizontal body 421 may be provided.

That is, as illustrated in the drawings, the first horizontal body 411 and the second horizontal body 421 may be placed to face each other, and the inside of the first horizontal body and the inside of the second horizontal body may denote an inner side formed by the first horizontal body 411 and the second horizontal body 421 facing each other

As illustrated in the drawings, the first hinge shaft 412 and the second hinge shaft 422 may be placed to face each other, and a predetermined gap d1 may be formed between the first hinge shaft 412 and the second hinge shaft 422.

In the inventive concept, the gap d1 between the first hinge shaft 412 and the second hinge shaft 422 is adjusted. This will be described later.

In addition, the first hinge shaft part 410 may include a first coupling part 414 which is located in a bore of the first vertical body 413 and a second coupling part 424 which is located in a bore of the second vertical body 423.

The first coupling part 414 and the second coupling part 424 may provide a first coupling point for coupling with the adapter which will be described later.

In addition, the first hinge shaft part 410 may include a first support part 415 which extends from the first vertical body 413 in the first direction (the opposite direction to Y) and is separated from the first horizontal body 411. In addition, the second hinge shaft part 420 may include a second support part 425 which extends from the second vertical body 423 in the first direction (the opposite direction to Y) and is separated from the second horizontal body 421.

The first support part 415 and the second support part 425 may provide a second coupling point for coupling with the adapter which will be described later.

Referring continuously to FIGS. 11 through 13, the hinge member 400 of the wiper blade assembly according to the inventive concept may include a hinge shaft gap adjusting member 430.

That is, as described above, the gap d1 between the first hinge shaft 412 and the second hinge shaft 422 is adjusted in the inventive concept, and the adjustment may be achieved by the hinge shaft gap adjusting member 430.

More specifically, the hinge shaft gap adjusting member 430 includes a base member 432 which is located at an upper end of the hinge member 400 and adjacent to the first hinge shaft part and the second hinge shaft part, a pressing member 431 which extends from a first end of the base member 432, and a connecting member 433 which extends from a second end of the base member 432.

That is, an end of the connecting member 433 may be connected to the second end of the base member 432, and the other end of the connecting member 433 may be connected to the hinge shaft parts 410 and 420.

More specifically, the connecting member 433 may include a first connecting member 433a which has an end connected to the second end of the base member 432 and the other end connected to the first hinge shaft part 410 and a second connecting member 433c which is separated from the first connecting member 433a by a predetermined gap and has an end connected to the second end of the base member 432 and the other end connected to the second hinge shaft part 420.

Here, the other end of the first connecting member 433a may be connected to the first hinge shaft part 410 when it is connected to a specific area of a lower end of the first vertical body 413 of the first hinge shaft part 410. In addition, the other end of the second connecting member 433c may be connected to the second hinge shaft part 420 when it is connected to a specific area of a lower end of the second vertical body 423 of the second hinge shaft part 420.

In addition, a space 433b may be formed between the first connecting member 433a and the second connecting member 433c separated from each other.

Here, the space 433b may provide a third coupling point for coupling with the adapter which will be described later.

As described above, the gap d1 between the first hinge shaft 412 and the second hinge shaft 422 is adjusted in the inventive concept, and the adjustment may be achieved by the hinge shaft gap adjusting member 430.

More specifically, when a user presses the pressing member 431 of the hinge shaft gap adjusting member 430 as indicated by reference character P, the pressing force may be transmitted to the base member 432, thereby changing the shape of each of the first connecting member 433a and the second connecting member 433c.

Such a change in the shape of each of the first connecting member 433a and the second connecting member 433c may increase the space 433b formed between the first connecting member 433a and the second connecting member 433c. Accordingly, the increased space 433b may change the gap between the first hinge shaft part and the second hinge shaft part respectively connected to the first connecting member and the second connecting member.

The change in the gap between the first hinge shaft part and the second hinge shaft part ultimately indicates an increase in the gap d1 between the first hinge shaft 412 and the second hinge shaft 422. That is, the gap between the first hinge shaft 412 and the second hinge shaft 422 after the pressing member 431 is pressed is greater than the gap between the first hinge shaft 412 and the second hinge shaft 422 before the pressing member 431 is pressed.

In this way, the gap d1 between the first hinge shaft 412 and the second hinge shaft 422 may be adjusted using the hinge shaft gap adjusting member 430 in the inventive concept.

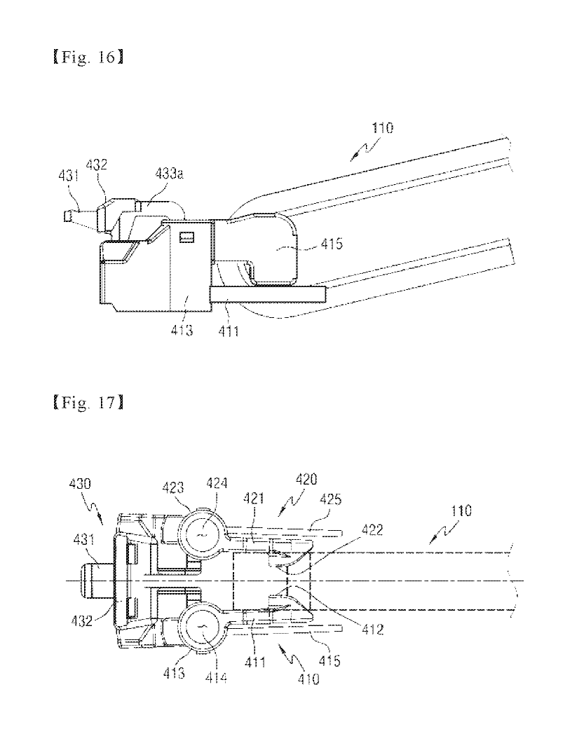

FIGS. 14 through 18 are schematic views illustrating a process of coupling the wiper arm directly to the hinge member according to the inventive concept. In FIGS. 14 through 18, other components of the wiper blade assembly excluding the hinge member are not illustrated for ease of description.

That is, the hinge member is located in a specific space inside the adapter 300 of FIG. 4 to provide a hinge shaft to the wiper arm. However, even without the adapter, the wiper arm can be directly coupled to the hinge shaft of the hinge member based on the same principle. Therefore, the coupling structure of the wiper arm according to the inventive concept can be fully understood from the coupling structure of the hinge member and the wiper arm.

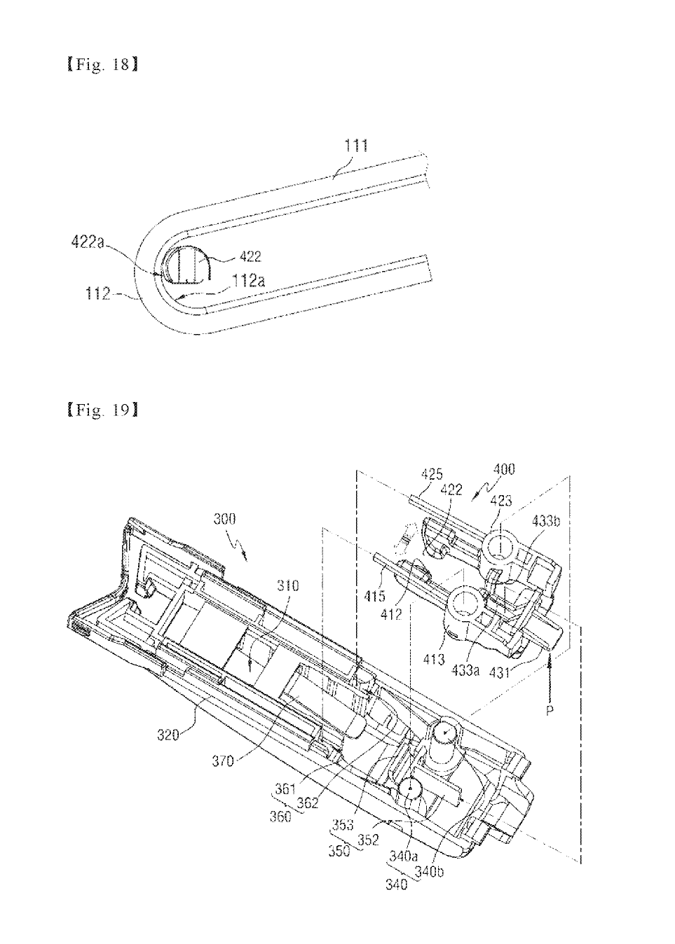

Referring first to FIGS. 14 and 18, the wiper arm 110 is inserted (in the Y direction) into a space between the first hinge shaft part 410 and the second hinge shaft part 420.

The insertion of the wiper arm 110 causes the U-shaped hook 112 of the wiper arm to be coupled to the hinge member 400 by the first hinge shaft 412 which protrudes toward the inside of the first horizontal body 411 and the second hinge shaft 422 which protrudes toward the inside of the second horizontal body 421.

More specifically, referring to FIG. 18, at least a portion of the inner circumferential surface 112a located on the inside of the hook 112 contacts at least a portion of the outer circumferential surface 422a of the hinge shaft 422, thereby coupling the wiper arm directly to the hinge shaft.

Here, as described above, it is not easy to couple a wiper blade wiper arm having a general structure to a wiper blade assembly because a user does not know to which part of the wiper blade assembly the wiper arm should be coupled.

In the inventive concept, however, the wiper arm and the wiper blade assembly can be coupled to each other by simply inserting the wiper arm 110 into the space between the first hinge shaft part 410 and the second hinge shaft part 420.

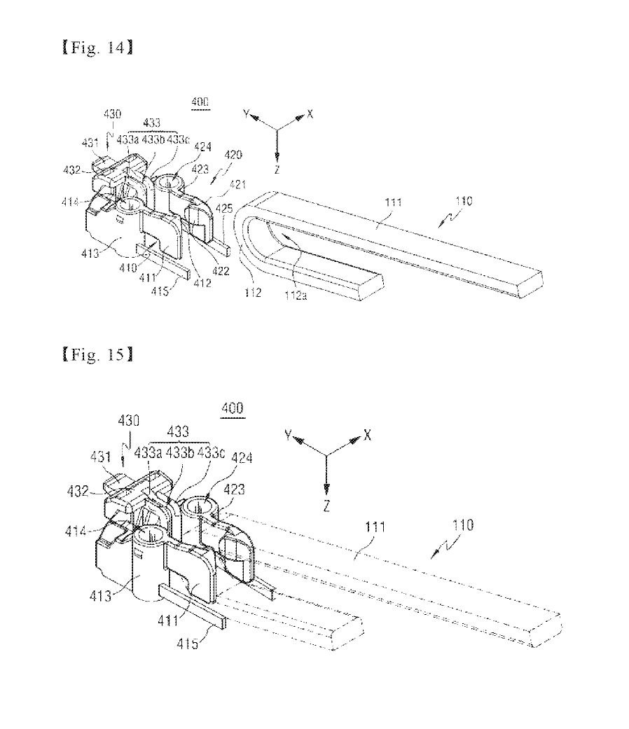

FIGS. 15 through 17 illustrate the wiper arm and the hinge member coupled to each other as viewed from various directions.

Here, the wiper arm and the hinge member can be separated from each other by adjusting the gap d1 between the first hinge shaft 412 and the second hinge shaft 422.

That is, as described above, a change in the gap between the first hinge shaft part and the second hinge shaft part denotes an increase in the gap d1 between the first hinge shaft 412 and the second hinge shaft 422. In other words, the gap between the first hinge shaft 412 and the second hinge shaft 422 after the pressing member 431 is pressed is greater than the gap between the first hinge shaft 412 and the second hinge shaft 422 before the pressing member 431 is pressed.

Therefore, while there is no change in the gap between the first hinge shaft part and the second hinge shaft part in a state where the wiper arm and the hinge member are coupled to each other, the gap between the first hinge shaft 412 and the second hinge shaft 422 is increased using the hinge shaft gap adjusting member 430 to separate the wiper arm and the hinge member from each other. Accordingly, the wiper arm can be separated from the first hinge shaft and the second hinge shaft.

When the wiper arm 110 is inserted (in the Y direction) into the space between the first hinge shaft part 410 and the second hinge shaft part 420, a standard for determining the degree of insertion is needed. In the inventive concept, the wiper arm may be prevented from being continuously inserted into the hinge member using a blocking member of the adapter which will be described later. This will be described later.

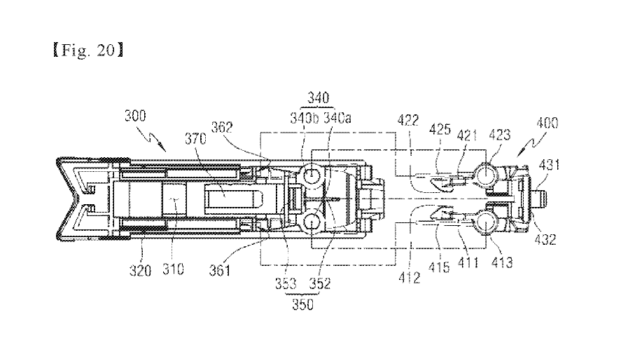

FIGS. 19 and 20 illustrate a process of coupling the adapter and the hinge member to each other according to the inventive concept.

Referring to FIGS. 19 and 20, the adapter 300 according to the inventive concept includes the body 320 and the wiper arm housing part 310 located in a specific area of the body 320.

In addition, the adapter 300 includes an insertion protrusion part 340 which is located in an area inside the body 320 and adjacent to an end of the wiper arm housing part 310. Specifically, the insertion protrusion part 340 may include a first insertion protrusion 340a and a second insertion protrusion 340b separated from the first insertion protrusion by a predetermined gap.

The insertion protrusion part is inserted into the hinge shaft parts of the hinge member of FIG. 6 to couple the adapter and the hinge member to each other. The first insertion protrusion may be inserted into the first coupling part 414 located in the bore of the first vertical body 413, and the second insertion protrusion may be inserted into the second coupling part 424 located in the bore of the second vertical body 423.

Here, as described above, the first coupling part 414 and the second coupling part 424 are coupled to the first insertion protrusion 340a and the second insertion protrusion 340b, respectively. Therefore, they may provide the first coupling point for coupling the hinge member and the adapter to each other.

In addition, the adapter 300 may include a blocking member 350 which is located in an area inside the body 320 and adjacent to an end of the wiper arm housing part 310. The blocking member 350 may include a first blocking member 353 which blocks continuous insertion of the wiper arm inserted into the wiper arm housing part 310 and a second blocking member 352 which is inserted into the space 433b formed between the first connecting member 433a and the second connecting member 433c of the hinge member 400 to block the first connecting member 433a and the second connecting member 433c from contacting each other.

Here, since the second blocking member 352 is inserted into the space 433b, it may provide the third coupling point for coupling the hinge member and the adapter to each other.

In addition, the adapter 300 may include a support groove 360 which is located in an area inside the body 320 and in an area of the wiper arm housing part 310. The support groove 360 may include a first support groove 361 and a second support groove 362 which is separated from the first support groove by a predetermined gap.

The first support groove 361 may extend from the first vertical body 413 in the first direction, and the first support part 415 separated from the first horizontal body 411 may be inserted into the first support groove 361. The second support groove 362 may extend from the second vertical body 423 in the first direction, and the second support part 425 separated from the second horizontal body 421 may be inserted into the second support groove 362.

That is, since the first support part 415 and the second support part 425 are respectively coupled to the first support groove 361 and the second support groove they may provide the second coupling point for coupling the hinge member and the adapter to each other.

In addition, referring to FIGS. 19 and 20, the adapter 300 according to the inventive concept may include a guide plate 370 which is located in a lower part of the wiper arm housing part 310 and has an end fixed to a specific area of the wiper arm housing part and the other end located in an area corresponding to the hinge shaft parts.

Here, the other end of the guide plate may be referred to as being located in the area corresponding to the hinge shaft parts based on a state where the hinge member and the adapter are coupled to each other.

That is, the wiper arm is inserted into the wiper arm housing part 320 and ultimately into the space between the first hinge shaft part and the second hinge shaft part. Here, the guide plate guides the wiper arm toward the hinge shaft parts.

As described above, in a wiper blade assembly having a general structure, a connector member is needed to couple a wiper arm to an adapter. In addition, in this structure, it is not easy for a beginner to couple or decouple the wiper arm to or from the adapter.

In the inventive concept, however, the wiper arm and the wiper blade assembly can be coupled to each other by simply inserting the wiper arm into the space between the first hinge shaft part and the second hinge shaft part.

In addition, in the inventive concept, the hinge shaft is provided through the hinge member separate from the adapter, and the gap d1 between the first hinge shaft 412 and the second hinge shaft 422 of the hinge member can be easily adjusted using the hinge shaft gap adjusting member. Accordingly, the wiper arm and the adapter can be easily separated from each other.

Therefore, even a beginner can easily couple or decouple the wiper blade assembly of the inventive concept to or from the wiper arm by pressing the pressing member of the hinge member.

While the inventive concept has been particularly shown and described with reference to exemplary embodiments thereof, it will be understood by those of ordinary skill in the art that various changes in form and detail may be made therein without departing from the spirit and scope of the inventive concept as defined by the following claims. The exemplary embodiments should be considered in a descriptive sense only and not for purposes of limitation.

### INDUSTRIAL APPLICABILITY

The present inventive concept relates to a wiper blade assembly, and more particularly, to a wiper blade assembly to or from which a wiper arm can be easily coupled or decoupled.

### Sequence List Pretext

| | |
|---|---|
| 100: wiper blade assembly | 200: coupling cover |
| 300: adapter | 400: hinge member |
| 500: cover member | 600: contact member |
| 700: elastic member | |

1. A wiper blade assembly comprising a hinge shaft coupled to a wiper arm, wherein the wiper arm is directly coupled to the hinge shaft.

2. The wiper blade assembly of claim 1, wherein the wiper arm comprises a U-shaped hook, wherein the U-shaped hook comprises an inner circumferential surface, and the hinge shaft comprises an outer circumferential surface, wherein at least a portion of the inner circumferential surface of the hook contacts at least a portion of the outer circumferential surface of the hinge shaft.

3. A wiper blade assembly coupled to a wiper arm and comprising a hinge shaft, wherein the hinge shaft comprises a first hinge shaft and a second hinge shaft separated from the first hinge shaft by a predetermined gap, wherein the predetermined gap is adjusted.

4. The wiper blade assembly of claim 1, comprising:
a coupling cover which covers a specific area of an elastic member and is coupled to the elastic member;
an adapter which is attached to or detached from the coupling cover; and
a hinge member which is located in a specific space inside the adapter, is coupled to the adapter, and provides the hinge shaft to the wiper arm.

5. The wiper blade assembly of claim 4, wherein the hinge member comprises a first hinge shaft part and a second hinge shaft part which is separated from the first hinge shaft part by a predetermined gap, and the hinge shaft comprises a first hinge shaft and a second hinge shaft, wherein the first hinge shaft part comprises a first vertical body, a first horizontal body which extends from the first vertical body in a first direction and the first hinge shaft which provides toward the inside of the first horizontal body, and the second hinge shaft part comprises a second vertical body, a second horizontal body which extends from the second vertical body in the first direction and the second hinge shaft which protrudes toward the inside of the second horizontal body.

6. The wiper blade assembly of claim 5, wherein the first hinge shaft part comprises a first coupling part which is located in a bore of the first vertical body, and the second hinge shaft part comprises a second coupling part which is located in a bore of the second vertical body.

7. The wiper blade assembly of claim 5, wherein the first hinge shaft part comprises a first support part which extends from the first vertical body in the first direction and is separated from the first horizontal body, and the second hinge shaft part comprises a second support part which extends from the second vertical body in the first direction and is separated from the second horizontal body.

8. The wiper blade assembly of claim 5, wherein the hinge member further comprises a hinge shaft gap adjusting member, wherein the hinge shaft gap adjusting member comprises a base member which is located at an upper end of the hinge member and adjacent to the first hinge shaft part and the second hinge shaft part, a pressing member which extends from a first end of the base member, and a connecting member which extends from a second end of the base member.

9. The wiper blade assembly of claim 8, wherein an end of the connecting member is connected to the second end of the base member, and the other end of the connecting member is connected to the hinge shaft parts, and the connecting member comprises a first connecting member which has an end connected to the second end of the base member and the other end connected to the first hinge shaft part and a second connecting member which is separated from the first connecting member by a predetermined gap and has an end connected to the second end of the base member and the other end connected to the second hinge shaft part.

10. The wiper blade assembly of claim 9, wherein the gap between the first hinge shaft and the second hinge shaft after the pressing member is pressed is greater than the gap between the first hinge shaft and the second hinge shaft before the pressing member is pressed.

11. The wiper blade assembly of claim 6, wherein the adapter comprises:
a body;
a wiper arm housing part which is located in a specific area of the body; and
an insertion protrusion part which is located in an area inside the body and adjacent to an end of the wiper arm housing part,
wherein the insertion protrusion part comprises a first insertion protrusion and a second insertion protrusion separated from the first insertion protrusion by a predetermined gap, wherein the first insertion protrusion is inserted into the first coupling part, and the second insertion protrusion is inserted into the second coupling part.

12. The wiper blade assembly of claim 9, wherein the adapter comprises:
a body;
a wiper arm housing part which is located in a specific area of the body; and
a blocking member which is located in an area inside the body and adjacent to an end of the wiper arm housing part,
wherein the blocking member comprises a first blocking member which blocks continuous insertion of the wiper arm inserted into the wiper arm housing part and a second blocking member which is inserted into a space between the first connecting member and the second connecting member of the hinge member.

13. The wiper blade assembly of claim 7, wherein the adapter comprises:
a body;
a wiper arm housing part which is located in a specific area of the body; and
a support groove which is located in an area inside the body and in an area of the wiper arm housing part,
wherein the support groove comprises a first support groove and a second support groove separated from the first support groove by a predetermined gap, wherein the first support part is inserted into the first support groove, and the second support part is inserted into the second support groove.
